(19) United States
(12) Patent Application Publication
(10) Pub. No.: US 2014/0055323 A1
(43) Pub. Date: Feb. 27, 2014

(54) VISUALISATION SYSTEM, NOTABLY FOR AN AIRCRAFT, WITH A TRANSPARENT SCREEN AND WITH PERIPHERAL SYMBOLOGY

(71) Applicant: Thales, Neuilly Sur Seine (FR)

(72) Inventors: Xavier SERVANTIE, Pessac (FR); Bruno Aymeric, St Medard En Jalles (FR); Sylvain Hourlier, Bordeaux (FR); Christophe Masson-Sibut, Villard-Bonnot (FR); Ludwig Joffroy, Evreux (FR)

(21) Appl. No.: 13/975,224

(22) Filed: Aug. 23, 2013

(30) Foreign Application Priority Data
Aug. 24, 2012 (FR) 1202292

(51) Int. Cl. G09G 5/37; G02B 27/01

(52) U.S. Cl. CPC G09G 5/37; G02B 27/01
USPC 345/7

(57) ABSTRACT

The general field of the invention is that of visualisation systems for an aircraft comprising a semi-transparent screen and electronic means suitable for generating a symbology displayed on said semi-transparent display screen, the symbology representing a parameter necessary for the piloting or navigation of the aircraft. The symbology according to the invention is partially or totally located on the periphery of the screen and comprises at least one moving pattern or a plurality of moving patterns, the speed and direction of the movement representing the relative difference between the value of the parameter at the present time and a reference value of said parameter, the patterns being immobilised when the value of the parameter at the present time attains said reference value. Different representations and different movements of the patterns are possible.

The general field of the invention is that of visualisation systems for a mobile vehicle for presenting information relating to piloting or navigation, superimposed on the external landscape. The more specific field of the invention is that of non-collimated, transparent or semi-transparent screens. The main application of the invention is the assistance with piloting for an aircraft.

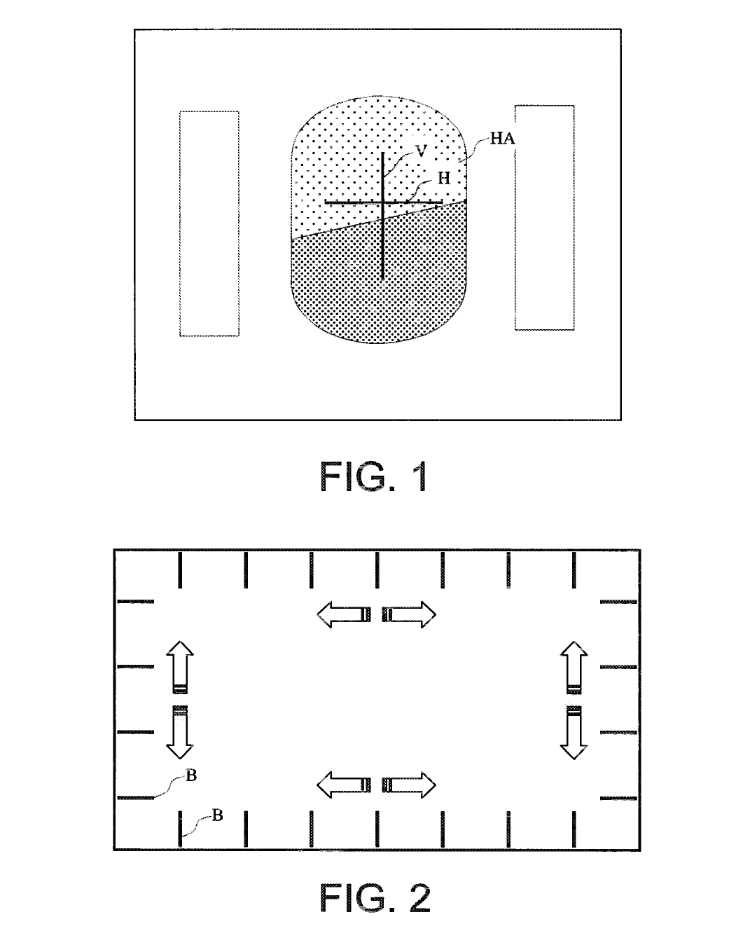

In the aeronautical field, during an instrument approach or more particularly when the crew does not use the autopilot, the crew must pilot the aircraft manually, following the commands given by a “flight director” or FD. This indicator is generally represented on the main piloting screen or “PFD”, the acronym for “Primary Flight Display”, by two bars superimposed on the artificial horizon HA as shown in FIG. 1. A first horizontal bar H gives it an instruction to adjust the attitude of the aeroplane or “pitch”. Any action on this bar is translated by an inflection of the vertical trajectory of the aeroplane. The second bar V is vertical and gives it an instruction to adjust the roll of the aeroplane. Any action on this bar is translated by an inflection of the horizontal trajectory of the aeroplane.

Instrument approaches generally end with a final visual step. From a certain height, the pilot must ensure that he has visual references of the runway in order to be able to control the trajectory without relying on instrumental data. This transition forces him to look outside before the runway is visible. During this time, the pilot no longer has instrumental references.

To overcome this difficulty, a device exists which is referred to as an “HUD”, the acronym for “Head-Up Display”. This instrument projects a collimated image, superimposed on the external landscape. This device maintains instrumental references in the visual field of the pilot during his visibility search. An HUD comprises a display, collimation optics and an optical component providing the superimposition of the information originating from the display onto the external landscape. This device requires complex and relatively expensive optics. Furthermore, the dimension of the pupil of the instrument is by nature limited.

Different emerging technologies enable the display of information on an active transparent screen or a specifically treated glass. This type of technology provides superimposed but non-collimated information at a cost which is lower than that of a conventional HUD. Moreover, it is very easy to provide colour information. Transparency provides large fields of vision over the external landscape, while supplying information to the pilot. However, the absence of collimation does not enable the superimposition of symbols like the command director in a precise manner onto the external landscape.

The object of the invention is to present a piloting symbology perfectly suited to this type of visualisation device. This symbology is based on the physiological properties of human peripheral vision which is highly sensitive to movement.

More precisely, the object of the invention is to provide a visualisation system for a mobile vehicle comprising a semi-transparent display screen and electronic means suitable for generating a symbology displayed on said semi-transparent display screen, said symbology representing at least one parameter necessary for the piloting or navigation of the mobile vehicle, characterised in that the displayed symbology is partially or totally located on the periphery of the screen and in that it comprises at least one moving pattern or a plurality of moving patterns, the speed and direction of the movement representing the relative difference between the value of the parameter at the present time and a reference value of said parameter, the pattern-s being immobilised when the value of the parameter at the present time attains said reference value.

Advantageously, if the parameter is a position or orientation parameter of the mobile vehicle, the direction of the movement of the pattern or of the plurality of patterns represents the relative difference between the value of the position or orientation of the mobile vehicle at the present time and a reference value of said position or said orientation of the mobile vehicle.

Advantageously the moving patterns are segments or points regularly spaced by a constant value.

Advantageously, the moving patterns are regularly spaced segments or points, the size or relative spacing of which represents the relative difference between the value of the parameter at the present time and a reference value of said parameter.

Advantageously, the moving pattern is a first rectangle occupying the periphery of the screen, the dimensions and/or the position of which vary according to the relative difference between the value of the parameter at the present time and a reference value of the parameter, said reference value being represented by a second rectangle of a fixed size.

Advantageously, the symbology comprises fixed peripheral patterns, serving as a reference point.

Advantageously, the semi-transparent display screen is an active matrix screen or semi-reflective passive screen, the system comprising means for projecting an image on said semi-reflective passive screen.

Advantageously, the mobile vehicle is an aircraft.

The invention will be more readily understood and other advantages will become evident from reading the non-limiting description which follows, referring also to the attached drawings, in which:

FIG. 1 shows an aircraft piloting symbology according to the prior art:

FIG. 2 shows a first symbology according to the invention;

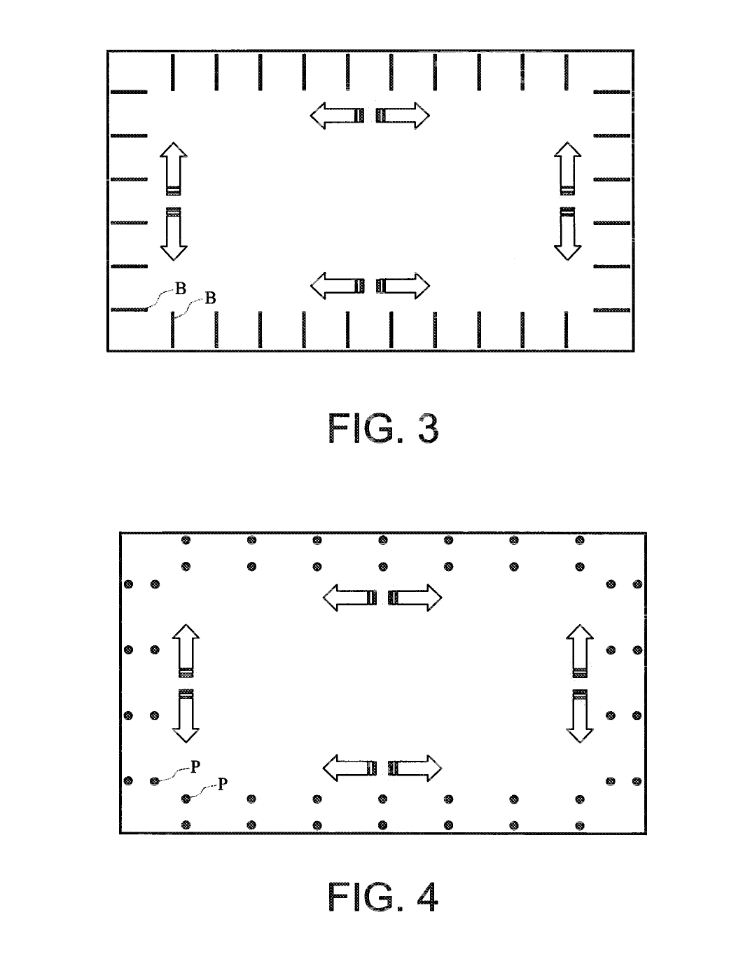

FIG. 3 shows a second symbology according to the invention;

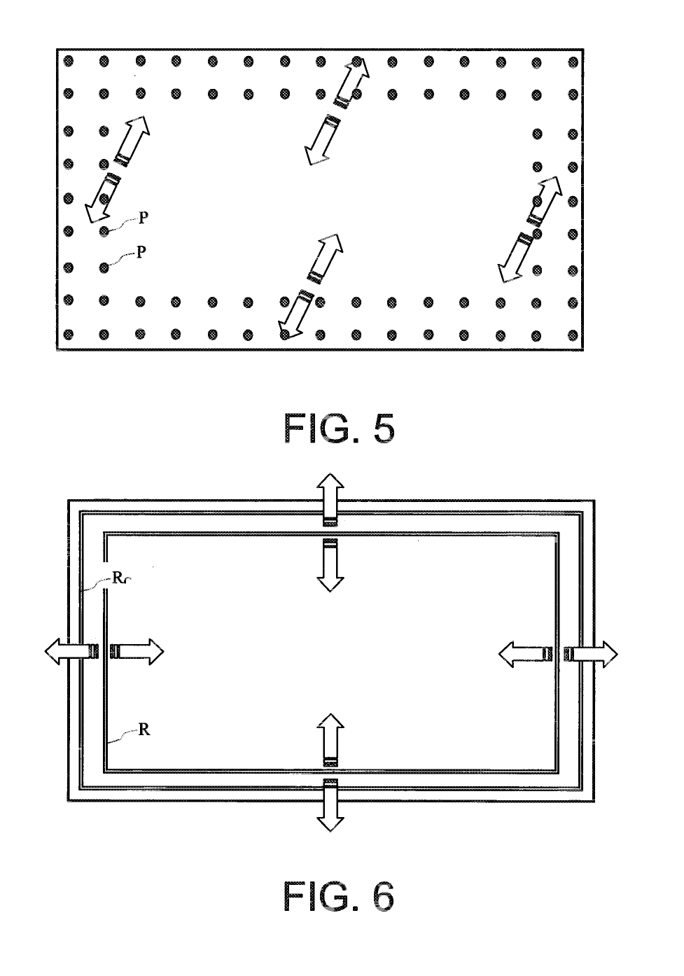

FIGS. 4 and 5 show a third symbology according to the invention provided with two different movements;

FIG. 6 shows a fourth symbology according to the invention.

Human vision is very powerful in terms of central vision. it enables the perception of fine details and colours in an angular field of less than 20°. In peripheral vision, visual perception is based on only a single type of retinal receptor sensitive to changes in luminance. The perception of colours disappears and the resolving power becomes very weak. Conversely, this peripheral vision is very effective in detecting contrast changes in time and in space such as flashes and/or light movements.

In this context, the symbology according to the invention consists in representing certain piloting or navigation information in the form of luminous objects moving horizontally or vertically according to the correction which the pilot must make. These luminous objects are disposed on the periphery of a transparent screen disposed in front of him, not impairing his central vision. The pilot no longer needs to take his eyes off the external view in order to obtain the information.

The symbology according to the invention can easily be implemented in a civilian or military aeroplane cockpit or in a surface vehicle, and more generally in any mobile system requiring a fine management of its trajectory and speed.

The invention applies below, by way of example, to the aeronautical field. In this case, the mobile vehicle is an aircraft. if this symbology according to the invention is implemented in a modem avionic system, said system comprises at least one cockpit visualisation device consisting of a semi-transparent display screen and an electronic and computing environment enabling a piloting or navigation symbology to be displayed on the display on this screen of the device, the necessary information originating from primary navigation systems such as inertial navigation units or the different external sensors of the craft. These systems are available on all modern aircraft.

Different technical principles exist for implementing a semi-transparent screen. HUD visors have already been mentioned. The semi-transparent display screen may also be an OLED active matrix screen, for example. The screen may also be a semi-reflective passive screen, the system then comprising means for projecting images on this semi-reflective passive screen which can be integrated into the roof of the craft. This semi-transparent screen may be made up of a matrix of dots reflecting and diffusing the light. The dots are disposed on a transparent surface. The dimensions of the screen must be sufficiently large to cover a visual field of more than 20 degrees seen by the pilot.

The displayed symbology may assume different shapes. By way of non-limiting examples, FIGS. 2 to 6 show different possible examples of symbology. In these figures, the double arrows indicate different directions of movement of the patterns. It will be understood that a multitude of variants of the symbologies shown in these figures exist, according to the parameter to be displayed, the aircraft type, the current mission and the requirements of the pilots or the aircraft manufacturer. These variants, which may relate to the shape, colour, size or spacing of the patterns, remain within the scope of this invention. All possible variants of movement of the symbols such as continuous, discontinuous or periodic flow movements also remain within the scope of this invention.

A first symbology according to the invention is shown in FIG. 2. It is composed of moving bars B of the same dimension and all spaced by the same interval. Two rows of vertical bars are disposed along the horizontal sides of the screen and two rows of horizontal bars are disposed along the vertical sides of the screen. The speed and direction of the movement of these bars represent the relative difference between the value of the parameter at the present time and a reference value of said parameter, the patterns being immobilised when the value of the parameter at the present time attains said reference value. It is easy to replace a command director with this type of symbology.

In a first variant shown in FIG. 3, the bars B can be moved further apart or closer together, for example according to the speed of the craft.

In a second variant shown in FIG. 4, the bars can be replaced by moving points P or lines of moving points. As shown in FIG. 5, all of the points can be provided with the same movement if, for example, the correction to be made is a correction of the trajectory or attitude of the aircraft. The direction, speed and orientation of the movement of the points then represent the direction, orientation and difference between the value of the trajectory correction at the present time and the reference value. As shown in FIG. 5, the double arrows representing the movement are all pointing in the same direction.

This last representation by points has the advantage of occupying a reduced space on the periphery of the screen while being perfectly perceived by the user.

In a final variant shown in FIG. 6, the symbology may comprise one or more rectangles R moving forwards or backwards. The pilot is thus given an idea of the difference between the real speed of the aircraft and the prescribed speed which may be represented by a fixed rectangle R_{c}.

In all the examples, the symbology according to the invention remains confined in the peripheral zone of the screen, the central field remaining unobstructed.

In most applications, the totality of the peripheral zone does not occupy more than one third of the total surface of the screen. This surface obviously depends on the size of the screen, the distance from the screen to the user, the patterns used, and the parameter shown.

In these different configurations, the symbology may comprise fixed peripheral patterns, serving as a reference point to the pilot and allowing him to judge the immobility of the moving symbols.

The main advantages of the symbology according to the invention linked to the exploitation of peripheral vision by means of a suitable symbology are as follows:
Great simplicity of implementation of the symbology;
Absence of visual disturbances in the central field of the pilot;
Great ease of use and great adjustment sensitivity to a given instruction.

1. Visualisation system for a mobile vehicle comprising a semi-transparent display screen and electronic means suitable for generating a symbology displayed on said semi-transparent display screen, said symbology representing at least one parameter necessary for the piloting or navigation of the mobile vehicle, wherein the displayed symbology is totally located on the periphery of the screen and in that it comprises at least one moving pattern or a plurality of moving patterns, the speed and direction of the movement representing the relative difference between the value of the parameter at the present time and a reference value of said parameter, the patterns being immobilised when the value of the parameter at the present time attains said reference value, the symbology being displayed in a visual field greater than 20 degrees, the periphery of the screen not occupying more than one third of the total surface of the screen.

2. Visualisation system according to claim 1, wherein, if the parameter is a position or orientation parameter of the mobile vehicle, the direction of the movement of the pattern or of the plurality of patterns represents the relative difference between the value of the position or orientation of the mobile vehicle at the present time and a reference value of said position or said orientation of the mobile vehicle.

3. Visualisation system according to claim 1, wherein the moving patterns are segments or points regularly spaced by a constant value.

4. Visualisation system according to claim 1, wherein the moving patterns are regularly spaced segments or points, the size or relative spacing of which represent the relative difference between the value of the parameter at the present time and a reference value of said parameter.

5. Visualisation system according to claim 1, wherein the moving pattern is a first rectangle occupying the periphery of the screen, the dimensions and/or the position of which vary according to the relative difference between the value of the parameter at the present time and a reference value of the parameter, said reference value being represented by a second rectangle of a fixed size.

6. Visualisation system according to claim 1, wherein the symbology comprises fixed peripheral patterns, serving as a reference point.

7. Visualisation system according to claim 1, wherein the semi-transparent display screen is an active matrix screen or semi-reflective passive screen, the system comprising means for projecting an image on said semi-reflective passive screen.

8. Visualisation system according to claim 1, wherein the mobile vehicle is an aircraft.

9. Visualisation system according to claim 2, wherein the moving patterns are segments or points regularly spaced by a constant value.

10. Visualisation system according to claim 2, wherein the symbology comprises fixed peripheral patterns, serving as a reference point.

11. Visualisation system according to claim 2, wherein the semi-transparent display screen is an active matrix screen or semi-reflective passive screen, the system comprising means for projecting an image on said semi-reflective passive screen.

12. Visualisation system according to claim 2, wherein the mobile vehicle is an aircraft.
